(19) United States
(12) Patent Application Publication
(10) Pub. No.: US 2026/0073800 A1
(43) Pub. Date: Mar. 12, 2026

(54) SYSTEMS AND METHODS FOR AUTONOMOUS AIR TRAFFIC MONITORING

(71) Applicants: Tanner D. Harms, Livermore, CA (US); Yuting Huang, Salinas, CA (US)

(72) Inventors: Tanner D. Harms, Livermore, CA (US); Yuting Huang, Salinas, CA (US)

(21) Appl. No.: 19/323,398

(22) Filed: Sep. 9, 2025

Related U.S. Application Data
(60) Provisional application No. 63/692,188, filed on Sep. 9, 2024.

(51) Int. Cl. G08G 5/80; G08G 5/21; G08G 5/265; G08G 5/72

(52) U.S. Cl. CPC G08G 5/80; G08G 5/21; G08G 5/265; G08G 5/727

(57) ABSTRACT

The present disclosure relates to systems and methods for providing improved air traffic control. Specifically, embodiments of the present invention are directed to provision of systems and methods for autonomous air traffic monitoring between ATC and pilots, whereby the automated systems and methods may be configured to advantageously provide an autonomous monitoring of air traffic transmissions to provide guidance and warnings to pilots and others as an additional safety measure and assistive device to reduce the chance of critical failures, such as midair or on ground collisions or aircraft.

### CROSS-REFERENCE TO RELATED APPLICATIONS

This application claims priority to U.S. Provisional Patent Application No. 63/692,188 filed Sep. 9, 2024, entitled Systems and Methods for Audio Based Autonomous Air Traffic Monitoring, which is hereby incorporated by reference in its entirety.

### TECHNICAL FIELD

The present disclosure relates to systems and methods for providing improved air traffic control. Specifically, embodiments of the present invention are directed to provision of systems and methods for autonomous air traffic monitoring between ATC and pilots, whereby the automated systems and methods may be configured to advantageously provide an autonomous monitoring of air traffic transmissions to provide guidance and warnings to pilots and others as an additional safety measure and assistive device to reduce the chance of critical failures, such as midair or on ground collisions or aircraft.

### BACKGROUND OF THE INVENTION

Air traffic control (ATC) is a service provided by air-traffic controllers who transmit instructions and clearances to aircraft operating on the ground and in the air. Currently, transmissions between ATC and pilots are processed and executed by humans, and human errors from misinterpretation, confirmation bias, fatigue, distractions, and lack of situational awareness can lead to serious accidents such as runway incursions, aircraft collisions and more.

Some systems attempt to alleviate the issue by providing text transcripts of the audio transmissions. However, these are not useful for pilots and air traffic controllers as reading the text transcript can take longer time than listening to the audio transmission, and transmissions irrelevant to the current pilot or controller can cause additional distractions.

Additionally, the execution and adherence to the ATC instructions and clearances are not autonomously monitored and relies on air traffic controllers who have to direct and monitor tens to hundreds of aircraft at the same time. Therefore, deviations from the assigned instructions due to human errors cannot be automatically detected.

### SUMMARY OF THE INVENTION

According to embodiments of the present disclosure, systems and methods for the autonomous monitoring of transmissions between ATC and pilots is disclosed herein. In certain embodiments, the automated systems and methods may be configured to advantageously fill these needs and address the aforementioned deficiencies by providing an autonomous monitoring of air traffic transmissions to provide guidance and warnings to pilots and others as an additional safety measure and assistive device.

According to an embodiment of the present invention, a computerized system for autonomous air traffic monitoring comprises: a processor and a non-transitory memory; the memory storing instructions which, when executed by the processor, cause the processor to: receive, via a communications processing unit, an air traffic control (ATC) transmission relating to a first aircraft, wherein the ATC transmission is transmitted via a first data transmission type and comprises a one or more of, an audio transmission, a digital text transmission, one or more geospatial coordinates; interpret, via the communications processing unit, aviation information contained in the ATC transmissions, wherein aviation information comprises one or more of trajectory information, taxi route, clearance command, grounding reference, flight route, hold short instruction, runway crossing instruction, runway assignment, and telemetry data of other aircraft; monitor, via the processor, a state of the first aircraft with respect to the interpreted transmission and prior transmissions; and generate a warning signal for the first aircraft, based at least in part on the aviation information and the state of the first aircraft, wherein the warning signal designates a delta between at least a portion of the aviation information and the state of the first aircraft.

According to an embodiment of the present invention, additional information associated with the first aircraft is sampled from one or more sensors selected from the group comprising an aircraft ADSB transceiver, an aircraft instrument and an aircraft flight computer.

According to an embodiment of the present invention, ATC transmission data processed by the system is regarded in comparison with the additional information sources.

According to an embodiment of the present invention, the warning signal comprises a signal perceptible to a pilot of the first aircraft.

According to an embodiment of the present invention, the system is further configured to adjust autopilot settings of the first aircraft, based at least in part on processed ATC transmission.

According to an embodiment of the present invention, the system is further configured to adjust one or more instrument settings of the first aircraft, wherein the instrument settings are selected from the group comprising, heading bugs, altitude bugs, speed bugs, aircraft altimeter settings, radio frequency settings, and/or navigation equipment settings.

According to an embodiment of the present invention, the system is further configured to overlay aircraft telemetry detected in the ATC transmission onto a graphical monitoring device of the first aircraft.

According to an embodiment of the present invention, the interpretation of the ATC transmission comprises altering from the first data transmission type to one or more secondary data types.

According to an embodiment of the present invention, the system is further configured to output the aviation information to a model consumable by one or more electronic devices.

According to an embodiment of the present invention, a computerized method for autonomous air traffic monitoring, the computerized method comprising the steps of: receiving, via a communications processing unit, an air traffic control (ATC) transmission relating to a first aircraft, wherein the ATC transmission comprises one or more of, an audio transmission, a digital text transmission, one or more geospatial coordinates; interpreting, via the communications processing unit, aviation information contained in the ATC transmission, wherein aviation information comprises one or more of trajectory information, taxi route, clearance command, grounding reference, flight route, hold short instruction, runway crossing instruction, runway assignment, and telemetry data of other aircraft; monitoring, via a processor, a state of the first aircraft with respect to the interpreted transmission and prior transmissions; and generating a warning signal for the first aircraft, based at least in part on the aviation information and the state of the first aircraft, wherein the warning signal designates a delta between at least a portion of the aviation information and the state of the first aircraft.

According to an embodiment of the present invention, the method further comprises the step of adjusting autopilot settings of the first aircraft, based at least in part on processed ATC transmission.

According to an embodiment of the present invention, the method further comprises the step of adjusting one or more instrument settings of the first aircraft, wherein the instrument settings are selected from the group comprising, heading bugs, altitude bugs, speed bugs, aircraft altimeter settings, radio frequency settings, and/or navigation equipment settings.

According to an embodiment of the present invention, the method further comprises the step of overlaying aircraft telemetry detected in the ATC transmissions onto a graphical monitoring device of the first aircraft.

According to an embodiment of the present invention, a system for aircraft state monitoring, comprises: a processor and a non-transitory memory; the memory storing instructions which, when executed by the processor, cause the processor to: receive an air traffic control (ATC) transmission; interpret, via said processor, aviation information contained in said ATC transmission into an aircraft status change message, wherein the aircraft status change message relates to one or more aircraft in a zone monitored by the processor; generate a zone status related to the one or more aircraft in the zone monitored by the processor based at least in part on said aircraft status change message; and monitor states of the one or more aircraft based at least in part on interpreted transmission and prior transmissions.

According to an embodiment of the present invention, the processor and the non-transitory memory further comprise instructions, when executed by the processor, cause the processor to: generate a warning message for one or more of the one or more aircraft; and transmit said warning message to the one or more aircraft of said one or more aircraft.

According to an embodiment of the present invention, the ATC transmission comprises a plurality of digital formats said plurality of digital formats selected from the group comprising audio, text, and geospatial coordinates.

According to an embodiment of the present invention, the origin of the ATC transmission is a ground-based controller.

According to an embodiment of the present invention, the origin of the ATC transmission is a first aircraft selected from the group of one or more aircraft.

According to an embodiment of the present invention, the ATC transmission comprises data selected from the group comprising taxi routes, clearance commands, grounding references, flight routes, hold short instructions, runway crossing instructions, runway assignments, and telemetry data.

According to an embodiment of the present invention, the processor and the non-transitory memory further comprise instructions, when executed by the processor, cause the processor to process additional information selected from the group comprising: primary radar, secondary radar, surface movement radar, ground-based ADSB receivers, satellite-based ADSB receivers, or aircraft ADSB transceivers.

According to an embodiment of the present invention, the processor and the non-transitory memory further comprise instructions, when executed by the processor, cause the processor to: process generate an updated zone status, based at least in part on said zone status and said additional information.

According to an embodiment of the present invention, the processor and the non-transitory memory further comprise instructions, when executed by the processor, cause the processor to display a graphical representation of said zone status on one or more displays selected from the group comprising ATC graphical displays, radar displays.

According to an embodiment of the present invention, the graphical representation is selected from the group comprising regional aircraft locations, indication of transmitting aircraft, assigned trajectory of regional aircraft, and indications of deviations from assigned trajectories.

According to an embodiment of the present invention, the processor and the non-transitory memory further comprise instructions, when executed by the processor, cause the processor to generate and transmit issuance of a warning messages.

According to an embodiment of the present invention, the processor and the non-transitory memory further comprise instructions, when executed by the processor, cause the processor to generate a proposal of modified aircraft trajectories and clearances for ATC approval.

### BRIEF DESCRIPTION OF DRAWINGS

The disclosure may best be understood by reference to the following description taken in conjunction with the accompanying drawings, which illustrate particular examples of the present disclosure. In the description that follows, like parts are marked throughout the specification and drawings with the same numerals, respectively. The drawing figures are not necessarily drawn to scale and certain figures may be shown in exaggerated or generalized form in the interest of clarity and conciseness.

FIG. 1A illustrates a block diagram of essential components of an example airborne monitoring system, in accordance with examples of the present disclosure.

FIG. 1B illustrates a block diagram of additional optional components of an example airborne monitoring system, in accordance with examples of the present disclosure.

FIG. 2A illustrates a block diagram of one implementation of a transmission processing module, in accordance with examples of the present disclosure.

FIG. 2B illustrates a block diagram of another implementation of a transmission processing module, in accordance with examples of the present disclosure.

FIG. 3 illustrates a block diagram of one implementation of an airborne monitoring module, in accordance with examples of the present disclosure.

FIG. 4A illustrates a block diagram of essential components of an example ground monitoring system, in accordance with examples of the present disclosure.

FIG. 4B illustrates a block diagram of additional optional components of an example ground monitoring system, in accordance with examples of the present disclosure.

FIG. 5 illustrates a block diagram of one implementation of a ground monitoring module, in accordance with examples of the present disclosure.

FIG. 6A illustrates a sample output of the airborne monitoring system displaying an assigned taxi route with associated clearances, in accordance with examples of the present disclosure.

FIG. 6B illustrates a sample output of the airborne monitoring system when the aircraft deviated from the assigned taxi route, in accordance with examples of the present disclosure.

FIG. 6C illustrates a sample output of the ground monitoring system highlighting an aircraft that deviated from its assigned taxi route, in accordance with examples of the present disclosure.

FIG. 7 is a process flow for an exemplary method for providing an airborne monitoring system, in accordance with examples of the present disclosure.

FIG. 8 is a process flow for an exemplary method for providing an ground monitoring system, in accordance with examples of the present disclosure.

### DETAILED DESCRIPTION OF THE INVENTION

Reference will now be made in detail to some specific examples of the disclosure including the best modes contemplated by the inventors for carrying out the disclosure. Various examples are illustrated in the accompanying drawings. While the disclosure is described in conjunction with these specific examples, it will be understood that it is not intended to limit the disclosure to the described examples. On the contrary, it is intended to cover alternatives, modifications, and equivalents as may be included within the spirit and scope of the disclosure as defined by the appended claims.

For example, the techniques of the present disclosure will be described in the monitoring the execution of ATC instructions and clearances by aircraft systems. However, it should be noted that the techniques of the present disclosure apply to a wide variety of vehicle systems, for example, automobile systems. Further, the techniques of the present disclosure may be applied to unmanned aircraft systems to, for example, monitor the execution of ATC instructions by the autonomous system. In the following description, numerous specific details are set forth in order to provide a thorough understanding of the present disclosure. Particular examples of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some examples include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted.

Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted. Additionally, arrows on the connections indicate general flow of information or order of processing. It does not necessarily mean a unidirectional flow of information, as a variety of information and variables can be shared between the entities and transmitted in either direction. For example, an audio signal may be first processed through an audio filtering module then processed through an automatic speech recognition (ASR) module. The arrow connecting the two modules indicates a general flow of information and processing order, but it will be appreciated that settings applied to said ASR module will also be shared with said audio filtering module, such as a setting that controls the length of each audio segment. Consequently, an arrow does not necessarily mean a unidirectional connection unless otherwise noted.

According to an embodiment of the present invention, the system may be configured to receive transmissions between ATC and pilots, processes the transmissions and monitor the execution of the transmissions using received aircraft telemetry. In certain embodiments, the airborne monitoring system may comprise a transmission processing module that receives transmissions between ATC and pilots and extracts the relevant information, and an airborne monitoring module that monitors the execution of the relevant ATC instructions and clearances with respect to aircraft telemetry. In preferred embodiments, the transmission processing module may be configured to receive analog or digital information, such as analog or digital audio, and process the information into machine usable format, such as text or other digital content derived from the processed analog or digital audio. One of ordinary skill in the art would appreciate that there are numerous types of analog or digital audio that could be received and processed by the transmission processing module, and embodiments of the present invention are contemplated for use with any appropriate processing means and methods.

In some examples, the received transmissions by the transmission processing module are in the form of audio signals transmitted through radios. In some examples, the transmissions are in the form of digital data transmitted through systems such as Aircraft Communications Addressing and Reporting System (ACARS). In certain embodiments, the airborne monitoring module receives processed instructions and clearances from the transmission processing module, identifies relevant instructions and clearances based on the current aircraft call sign, and identifies aircraft parameters to be monitored. The airborne monitoring module further receives aircraft telemetry through aircraft systems, through Automatic Dependent Surveillance-Broadcast (ADS-B) transceivers, or by other means, and uses said aircraft telemetry to monitor the compliance to relevant ATC instructions and clearances. In some examples, the airborne monitoring module monitors aircraft telemetry such as altitude, heading, speed, geoposition, taxi route, runway crossing clearances, radio frequency settings, or flight computer approach settings. In certain embodiments, all or a portion of the telemetry data monitored by the airborne monitoring module may be received directly from electronic equipment integrated into or otherwise associated with an aircraft. In other embodiments, all or a portion of the telemetry data may be provided over the air from remote electronic monitoring equipment, such as equipment operated by air traffic control. In still further embodiments, all or a portion of the telemetry data may be provided by one or more electronic sensors associated with the airborne monitoring module, such as global positioning systems (GPS), altimeters, gyroscopes, optical systems, or any combination thereof. One of ordinary skill in the art would appreciate that there are numerous types of telemetry data, and electronic sensors associated therewith, that could be utilized with embodiments of the present invention, and embodiments of the present invention are contemplated for use with any appropriate telemetry data and electronic sensors for the provision or processing of such telemetry data.

In certain preferred embodiments, the airborne monitoring system may also comprise an airborne interface module for interfacing with relevant aircraft systems, pilots, dedicated monitors, personal electronic devices and/or audio devices to provide graphical, haptic aural, or other discernable feedback to the pilots or otherwise interact directly with aircraft systems. In some examples, the airborne interface module optionally comprises an autopilot interfacing module, which takes the aviation instructions from the airborne monitoring module and updates the autopilot settings. In preferred embodiments, updates to the autopilot settings require approval from the pilot. In other embodiments, updates to autopilot settings may be completed by the autopilot interfacing module, independent of pilot approval. In still further embodiments, the automatic updates to autopilot settings by an autopilot interfacing module may require system confirmation of verification of the update from a third party system or device, such as confirmation from air traffic control systems.

In some examples, the airborne interface module optionally comprises of an instrument interfacing unit, which takes the aviation instructions from the airborne monitoring module and displays those on the aircraft instruments, including but not limited to: setting heading bugs on the aircraft heading indicator, setting altitude bugs on the aircraft altimeter, adjusting the aircraft altimeter setting, adjusting radio frequencies on aircraft radios, setting parameters in flight computers. In some examples, the airborne interface module optionally comprises a graphical guidance unit that displays the aviation instructions received from the airborne monitoring module in a graphical manner on dedicated displays or pilot's personal electronic devices, including but not limited to displaying taxi routes graphically overlaid on airport diagrams, displaying hold short instructions overlaid on airport diagrams, displaying runway crossing or entry clearances overlaid on airport diagrams, displaying route and altitude assignments overlaid on aviation charts. In these embodiments, advantageously, the airborne monitoring module can be used as a calibration system for electronic systems on the aircraft, to ensure accuracy of the various sensors and equipment. If the system detects too great of a variance between the data points in the airborne monitoring module and the data points provided by the aircraft systems, the airborne monitoring module may be configured to alert third party systems, such as those operated by air traffic control or by the operator of the aircraft, that the aircraft may need maintenance or other service to ensure accuracy of the aircraft's onboard systems.

Another aspect of the present disclosure relates to a ground monitoring system. This system receives transmissions between ATC and pilots, processes the transmissions and monitors the execution of the transmissions using received aircraft telemetry of all aircraft under the control of the air traffic control center. This ground monitoring system comprises a transmission processing model and a ground monitoring module. In some examples, the transmission processing module may be of the same configuration as the transmission processing module used in the airborne monitoring system. This module receives transmissions of aircraft under the control of the air traffic control center using the ground monitoring system and autonomously interprets their content for use in air traffic control efforts. The ground monitoring module monitors the execution of ATC commands with respect to the aircraft telemetry data of aircraft under the control of the air traffic control center.

In some examples, transmissions are received in the form of radio signals that constitute audio. In some examples, transmissions are received in the form of digital data, as with ACARS transmissions. In some examples, transmissions processed by the ground monitoring system are between a single pilot and a single ground entity. In some examples, there may be multiple pilots and multiple ground entities. In some examples, the ground monitoring system receives telemetry from a plurality of sources, comprising: ATC primary or secondary radar, ATC ground radar, airport sensor systems, and internet-based data sources. One of ordinary skill in the art would appreciate that there are numerous types of signals and data that could be transmitted and received by the ground monitoring system, and embodiments of the present invention are contemplated for use with any appropriate signal and data types.

The ground monitoring system may also comprise a ground interface module which relates processed aviation data to system users. In some examples, the ground interface module transmits information to and from ATC monitors which are in use by ATC operators for a plurality of systems in addition to those disclosed. In some examples, the ground interface module transmits to and from dedicated monitors that are used specifically for the disclosed systems. In some examples, the ground interface module relates information to users via audio devices, and in some examples, the ground interface module transmits information to and from ATC personal electronic devices such as tablets, laptop computers, or cellular phones. Transmission of the information could be performed over any appropriate transmission means, including, but not limited to, wired transmission means, wireless transmission means (such as WIFI, cellular, or BLUETOOTH), or any combination thereof. One of ordinary skill in the art would appreciate that there are numerous types of devices the ground interface module could be configured to transmit data to and display or otherwise represent the data on, and embodiments of the present invention are contemplated for use with any appropriate device and/or data.

The system may be further comprised of a transmission processing module, which, in certain embodiments, is present in both the airborne monitoring system and the ground monitoring system in the same or in various forms. In preferred embodiments, the transmission processing module comprises a processor and memory, wherein the memory stores a model that, when executed by the processor, takes transmission data as input and provides relevant aviation data as output. In some examples, the input transmission is in the form of audio signals transmitted via radio. In some examples, the input transmission includes strings of text. In other examples, the input transmission includes other sources of digital data. The output data may also exist in multiple forms. In some examples, the output data represents a series of aviation instructions in the form of strings of text. In some examples, the output may be geospatial coordinates representing commanded aircraft trajectories. In some examples, the output data may represent digital data interpretable as aviation information for appropriately configured processors, though not readily interpreted by humans, such as instructions to autopilot systems onboard an aircraft.

In certain embodiments, the model used to process input transmission data to output aviation data may exist in a variety of forms. In some examples, the model is a general purpose neural network trained to process multi-modal transmission inputs to multi-modal aviation outputs directly in a single step. In some examples, the model is configured such that separate neural networks handle each input modality separately and synthesize the corresponding outputs into aviation instructions, possibly by the use of another neural network. In some examples multiple stages are required to process single modalities, such as processing audio through an automatic speech recognition (ASR) network followed by a large language model (LLM) to yield aviation instructions. In some examples, additional data is stored on the memory of the transmission processing module which is used to inform the output of the model. While processing of the data may be accomplished via a neural network or other means as detailed above, one of ordinary skill in the art would appreciate that there are numerous other forms of artificial intelligence and machine learning that could be utilized with embodiments of the present invention, and embodiments of the present invention are contemplated for use with any appropriate artificial intelligence or machine learning methods. Throughout this disclosure, where a neural network is noted, one of ordinary skill in the art would appreciate that there could be alternative machine intelligence systems that could be used in lieu of or conjunction with a neural network, such a artificial narrow intelligence (ANI) systems, broader machine learning systems, such as support vector machines (SVMs), and many others. Any place in this disclosure wherein a neural network is referenced, it is contemplated that use of an appropriate alternative artificial intelligence or machine learning system could be utilized in lieu of or conjunction with such a neural network.

The disclosed system is unique in that it autonomously monitors aircraft state and state evolution based on a plurality of transmissions commonly used in aviation communications. Additionally, the processed aviation instructions may take any form, comprising text and geospatial coordinate trajectories, which can easily be graphically represented to pilots and ATC controllers. Additionally, in certain embodiments, the disclosed system autonomously compares current trajectories of the monitored aircraft with ATC instructions to generate warnings or otherwise automatically adjust autopilot settings when deviations occur. Warnings could be of numerous types, including, but not limited to, user perceptible warnings, computer perceptible warnings, or any combination thereof. User perceptible warnings may include, but are not limited to, audible warnings (e.g., klaxons, sirens, computer generated audio, prerecorded audio, audio transmissions), visual warnings displayed on a GUI, visual warnings displayed via one or more connected components (e.g., lights, visual indicators), tactile warnings (e.g., haptic feedback), or any combination thereof. Computer perceptible warnings may include, but are not limited to, software warnings (e.g., data transmissions processed into warning or error related machine-readable messages), hardware warnings (e.g., detection of physical state changes that are processed into electrical or other signals for processing by a machine), or any combination thereof. One of ordinary skill in the art would appreciate that there are numerous types of warnings that could be utilized with embodiments of the present invention, and embodiments of the present invention are contemplated for use with any appropriate type of warning. Users of the system may choose to ignore the warnings or to allow the autopilot settings to be adjusted autonomously by the system. Further, machine perceptible warnings may be used in both manned and unmanned flight operations, such that in cases where autopilot or autonomous flight systems are being utilized, the machine perceptible warnings may be identified and processed by a computerized system controlling an aircraft, and thereby allowing the computerized control system to make necessary changes to eliminate or reduce issues related to the warnings. In still further embodiments, the systems may be configured to process human/user perceptible warnings into machine perceptible warnings, such as via vision systems for visual warnings, and audio processing systems for audible warnings. In this manner, the system may be integrated with existing warning systems to provide automation. Thus, the disclosed may be useful in both manned and unmanned flight configurations.

The disclosed system is unique in that the architecture of the system is distinct from other known systems. Specifically, preferred embodiments of the present invention comprise multi-modal processing capability to translate a plurality of transmission data types including audio, text, and other digital data to a plurality of aviation output types including geospatial coordinate trajectories and lists of aviation instructions. Advantageously, the output data may be directly utilized to autonomously monitor the state and trajectory of one or more aircraft with respect to current trajectories with no input from the pilot or ATC operator.

As mentioned above, automating monitoring of an aircraft compliance with ATC instructions and clearances can lead to increased aviation safety. Currently, all instructions and clearance transmissions from ATC are interpreted and executed by pilots and are therefore prone to human error and other limitations, such as reaction time, attention, physical health/disability, and other limitations. Current transmissions are predominately passed by audio transmissions through radios, but digital data communication systems such as Aircraft Communications Addressing and Reporting System (ACARS) and other systems are also used. It is therefore desirable to have an autonomous system that automatically processes the transmissions between ATC and pilots. Embodiments of the present invention provide autonomous systems which actively monitor aircraft state and state evolution (interchangeable with trajectory), compare with the assigned instructions, and generate warnings to ATC and/or pilots in case of deviations from the assigned instructions. Certain embodiments of the system may be configured to provide early warning of deviations to prevent dangerous situations such as collision with other aircraft or terrain, runway incursions and more. Still further embodiments of the present invention may be configured to provide an autonomous system that generates visual guidance based on the ATC transmissions for pilots, such as taxi routes and assigned flight plans, to reduce pilot workload and prevent pilot deviations.

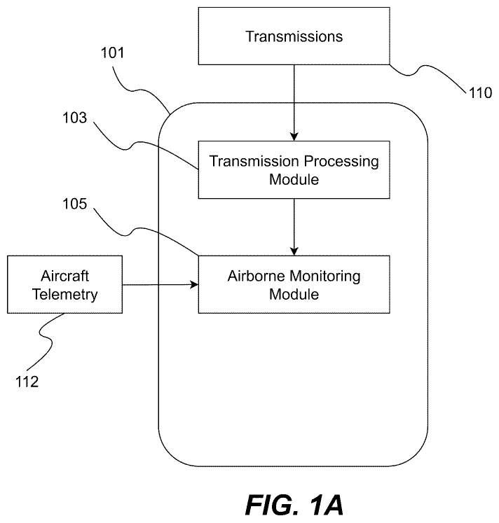

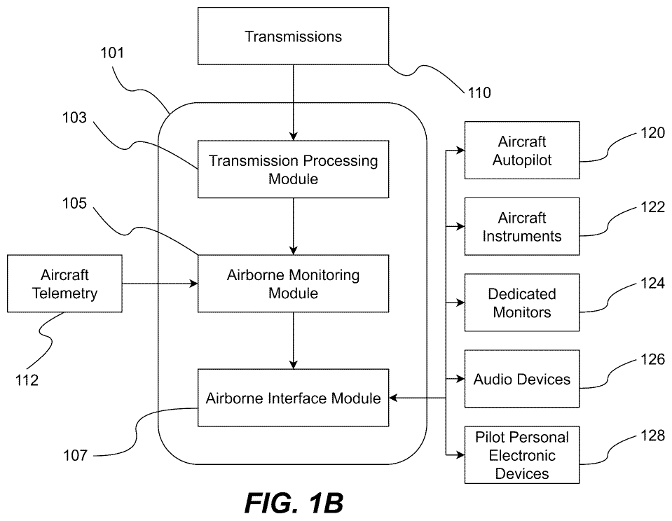

FIG. 1A illustrates a block diagram of components of an example airborne monitoring system, in accordance with preferred examples of the present disclosure. Airborne monitoring system 101 comprises transmission processing module 103 and airborne monitoring module 105. Transmission processing module 103 receives transmission 110 and outputs aviation instruction and clearance information. Airborne monitoring module 105 receives aviation instruction and clearance information from transmission processing module 103 and aircraft telemetry 112 and monitors the execution and compliance with the instructions and clearances. In preferred embodiments of the present invention, the airborne monitoring system 101 comprises one or more processing means, such as one or more central processing units coupled with electronic memory and non-transitory storage means configured to store machine readable instructions configured to operate and direct the transmission processing module 103 and airborne monitoring module 105.

In one example, transmissions 110 are in the form of audio transmission delivered through radios. In other examples, transmissions 110 can be data transmitted through Aircraft Communications Addressing and Reporting System (ACARS) or other systems. Transmissions 110 can originate, for instance, from air traffic controllers, other pilots in the airspace, other aircraft monitoring systems, or any combination thereof. Transmissions 110 can address the aircraft where airborne monitoring system 101 is located, other aircraft in the airspace, other entities, or any combination thereof.

In some examples, aircraft telemetry 112 can originate from aircraft avionics, including but not limited to altimeter, heading indicator, GPS receiver, or any combination thereof. In other examples, aircraft telemetry 112 can originate from external modules such as Automatic Dependent Surveillance-Broadcast (ADS-B) transceivers that may be portable or permanently mounted in the aircraft. In other examples, aircraft telemetry 112 can originate from GPS receivers on pilot's personal electronic devices such as smart phones or tablets. In other examples, aircraft telemetry 112 can originate from devices connected to the internet, where telemetry data is retrieved from the internet or cloud storage. One of ordinary skill in the art would appreciate that aircraft telemetry 112 could originate from a variety of sources, and embodiments of the present invention are contemplated for use with aircraft telemetry 112 received from any appropriate source.

FIG. 1B illustrates a block diagram of additional optional components of an example airborne monitoring system, in accordance with examples of the present disclosure. Airborne monitoring system 101 comprises transmission processing module 103 and an airborne monitoring module 105, and an airborne interface module 107. Airborne interface module 107 may be configured to receive monitoring results from airborne monitoring module 105 and interface with aircraft systems and/or the pilot. In some examples, airborne monitoring module 105 may be configured to interface with aircraft autopilot system 120, for instance, by automatically setting autopilot reference heading and/or altitude when relevant ATC instructions are received. In certain embodiments, the setting of autopilot references can be done with or without pilot confirmation.

In further examples, airborne interface module 107 may be configured to interface with aircraft instruments 122, for instance, by displaying the relevant aviation instructions and/or clearances from airborne monitoring module 105 and displaying those instructions and/or clearances on the aircraft instruments, including but not limited to: setting heading bugs on the aircraft heading indicator, setting altitude bugs on the aircraft altimeter, setting speed bug on the aircraft airspeed indicator, adjusting the aircraft altimeter setting, adjusting the aircraft radio frequency settings, adjusting navigation equipment settings, or any combination thereof.

In still further examples, airborne interface module 107 may be configured to interface with dedicated monitors 124 that are portable or permanently mounted in a cockpit to provide graphical interfaces for pilots. In other examples, airborne interface module 107 is configured to interface with one or more audio devices 126 that are portable or permanently mounted in a cockpit to provide audial information, guidance and warnings to pilots. In other examples, airborne monitoring module 105 may be configured to interface with pilots' personal electronic devices 128 such as smart phones, tablets or devices used as electronic flight bags (EFB, electronic devices such as smart phones or tablets used by pilots to replace paper charts). In each case, interface with various devices and equipment noted in this disclosure can be done in a variety of means, such as wirelessly, wired or a combination thereof. One of ordinary skill in the art would appreciate that there are numerous types of interfaces that could be used with embodiments of the present invention, and embodiments of the present invention are contemplated for use with any appropriate interface means.

In certain embodiments, graphical user interfaces (GUIs) may be provided by airborne interface module 107, wherein such GUIs can comprise displaying various visual representation of data, such as taxi routes graphically overlaid on airport diagrams, displaying hold short instructions overlaid on airport diagrams, displaying runway crossing or entry clearances overlaid on airport diagrams, displaying route and altitude assignments overlaid on aviation charts, or any combination thereof. One of ordinary skill in the art would appreciate that there are numerous visual representations of data that could be utilized with embodiments of the present invention, and embodiments of the present invention are contemplated for use with any appropriate visual representation of data, via a GUI or otherwise.

Airborne interface module 107 may also be configured to receive user inputs, such as through an aircraft autopilot system 120, one or more aircraft instruments 122, one or more dedicated monitors 124, one or more audio devices 126, one or more pilots' personal electronic devices 128, or any combination thereof. Said user inputs can be used to adjust settings of airborne monitoring system 101, including but not limited to, choice of aircraft telemetry to monitor, current aircraft callsign, warning display style, and audio levels.

According to an embodiment of the present invention, a portion of or the entire airborne monitoring system 101 can operate on one or more devices, including but not limited to, computers with displays, laptop computers, tablet computers, smart phones, aircraft onboard computers, specialized computing devices, or any combination thereof. If necessary, certain embodiments may utilize additional hardware that provides connections to aircraft radios, ADSB transceivers, autopilots, instruments for data exchanges, other electronic devices, or any combination thereof. In some examples, all components of the airborne monitoring system 101 can operate on a single device, for instance, a device located inside the aircraft. In other examples, components of airborne monitoring system 101 can be operated on multiple devices at different locations, connected through the hardwire data lines, wireless data transmission systems, connected by the internet, or any combination thereof.

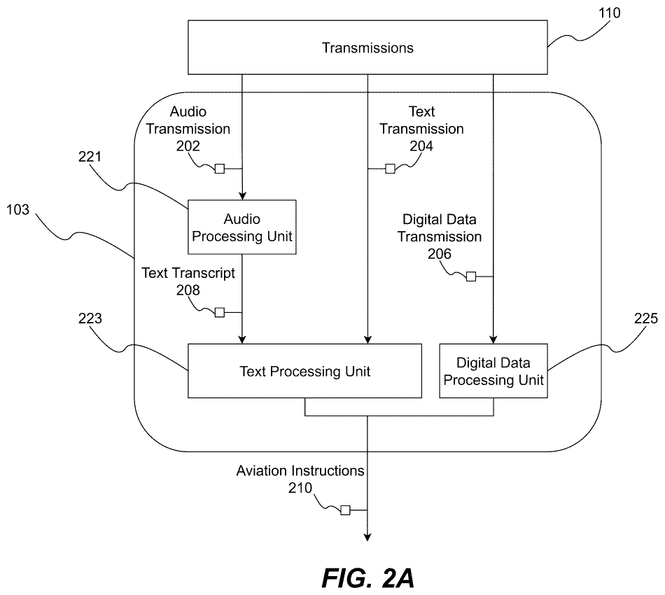

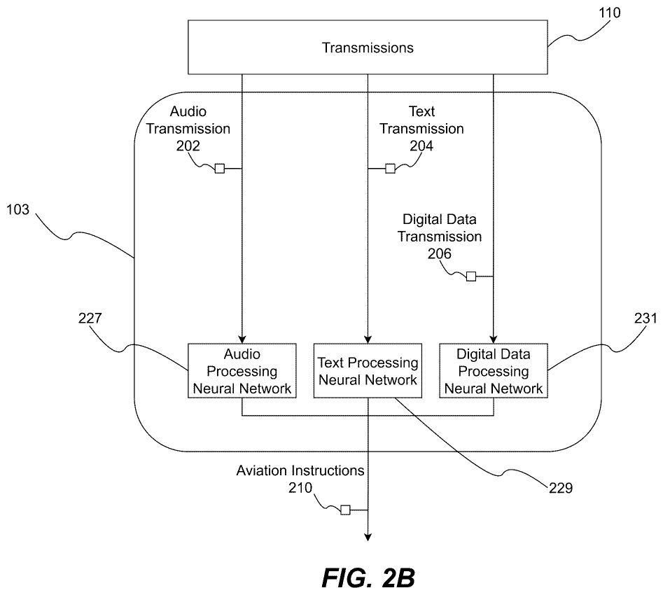

FIG. 2A illustrates a block diagram of one implementation of transmission processing module 103, in accordance with examples of the present disclosure. Transmissions 110 are first separated into audio transmission 202, text transmission 204 and digital data transmission 206. Audio transmission 202 is then passed into audio processing unit 221, which computes a text transcript 208 of the audio transmission 202. In some examples, audio processing unit 221 can be implemented with a generic automatic speech recognition (ASR) algorithm performed on an appropriate computing device. In other examples, audio processing unit 221 can be implemented with a combination of audio filters to reduce noise in the audio transmission 202, a generic automatic speech recognition (ASR) algorithm, and a separate neural network to correct the aviation specific text for improved accuracy of the text transcript 208. Text transcript 208 and text transmission 204 can then be passed into text processing unit 223, which processes the text into aviation instructions 210. The relevant aviation instructions 210 may include, but is not limited to, taxi routes, hold short instructions, runway crossing instructions, flight routes, takeoff clearances, assigned heading, assigned altitude, assigned speed, frequency changes, airspace entry clearances, runway assignments, landing clearances, or any combination thereof.

In one implementation, text processing unit 223 uses keyword detections, such as numbers, airline name, aviation alphabet, “runway”, “taxi”, “feet”, “knots”, “heading”, “cleared for take off”, “cleared to land”. Based on the keywords or combination of keywords, the instruction types can be identified, and relevant parameters are identified for each type of instruction. Digital data transmission 206 is passed into digital data processing unit 225, which computes the corresponding aviation instructions 210.

In one example, aviation instructions 210 are data packages comprising: source, destination, type, and parameters. In further examples, transmission 110 may be an audio transmission 202 given as: “N123, LA approach, good morning, turn left heading 270”. In this example, “N123” is the callsign of the intended destination of the transmission, “LA approach” is the source of the transmission, “good morning” is a greeting that gets ignored by text processing unit 223, and “turn left heading 270” is the ATC instruction, which is of type heading, with parameters left and 270.

FIG. 2B illustrates a block diagram of another implementation of transmission processing module 103, in accordance with examples of the present disclosure. Transmissions 110 are first separated into audio transmission 202, text transmission 204 and digital data transmission 206. Audio transmission 202 is processed through audio processing neural network 227, text transmission 204 is processed through text processing neural network 229, digital data transmission 206 is processed through digital data processing neural network 231. Audio processing neural network 227, text processing neural network 229, and digital data processing neural network 231 output aviation instructions 210. In one example, 227-231 each are a single neural network. In other examples, 227-231 each are multiple neural networks operating in series or in parallel. In an alternative implementation of transmission processing module 103, a general purpose neural network is used to process multi-modal transmission inputs to multi-modal aviation outputs directly in a single step.

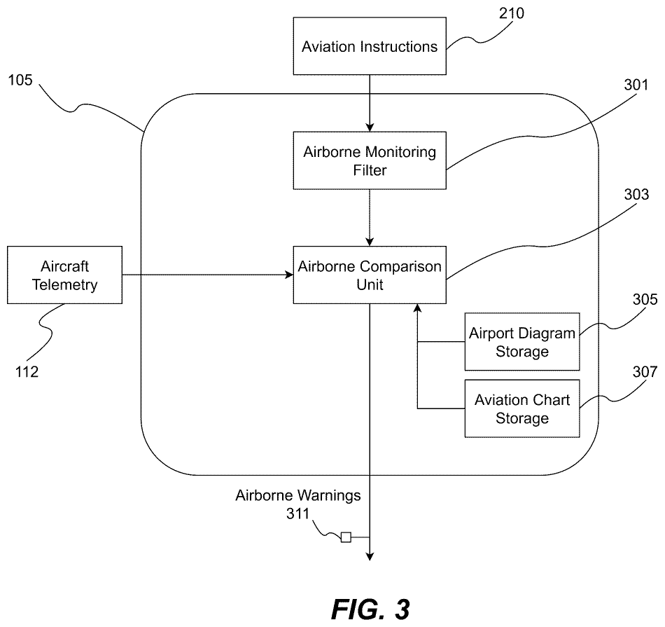

FIG. 3 illustrates a block diagram of one implementation of airborne monitoring module 105, in accordance with examples of the present disclosure. Airborne monitoring module 105 takes aviation instructions 210 from transmission processing module 103. Aviation instructions 210 are then passed into airborne monitoring filters 301. In one implementation, airborne monitoring filter 301 removes all instructions designated for callsigns that do not match the callsign of the current aircraft. In another implementation, airborne monitoring filter 301 disables the monitoring of certain parameters based on pilot settings. The outputs of airborne monitoring filter 301 are passed into airborne comparison unit 303, which also take aircraft telemetry 112 as input. Airborne comparison unit 303 compares the current aircraft telemetry with the assigned values from the ATC transmission, and outputs airborne warnings 311 when deviations are detected. Airborne monitoring module 105 optionally comprises airport diagram storage 305 and aviation chart storage 307, to assist in the monitoring of compliance of taxi instructions or routes. In certain embodiments, airborne warnings 311 may also comprise warnings related to potentially critical conflicts between directions received in the ATC transmission and information about the aircraft telemetry 112 utilized by the airborne comparison unit 303. For instance, if a change in aircraft telemetry is requested by instructions received from ATC transmission(s) that would result in a potential collision with another aircraft, or other critical event, the system may be configured to output airborne warnings 311 not only to the pilot(s), but also send a return message to ATC for clarification or update/recalculation.

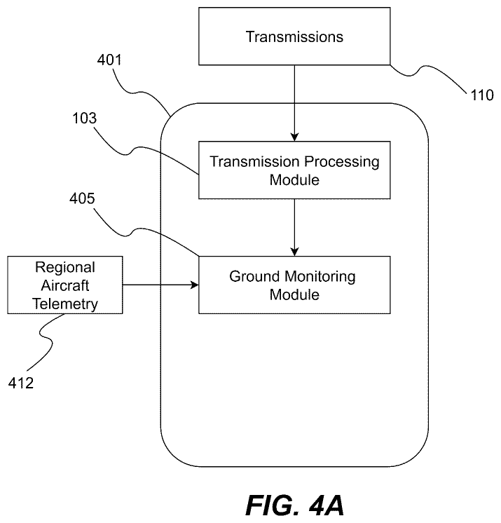

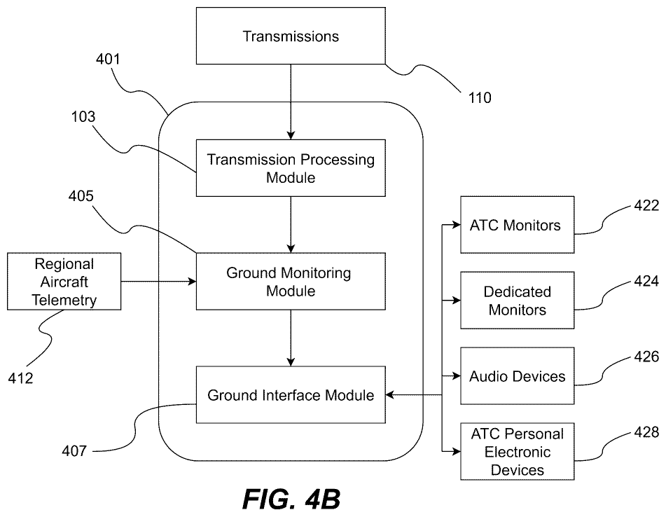

FIG. 4A illustrates a block diagram of a preferred embodiment of a ground monitoring system, in accordance with examples of the present disclosure. Ground monitoring system 401 comprises transmission processing module 103 and ground monitoring module 405. In one example, transmission processing module 103 is similar to or the same as that used in airborne monitoring system 101, with implementations detailed in FIG. 2A and FIG. 2B. Ground monitoring module 405 receives output of transmission processing module 103 and regional aircraft telemetry 412 monitors the compliances of each aircraft with their assigned instructions and clearances and outputs warnings when deviations are detected. Regional aircraft telemetry 412 comprises telemetry for aircraft under the control of the current air traffic controller. In preferred embodiments, the regional aircraft telemetry 412 comprises telemetry for all aircraft under the control of the current air traffic controller, however, in other instances, the regional aircraft telemetry 412 may comprise a subset of the aircraft, for instance, where an air traffic control system is split between two or more airports, or when an air traffic control system is down and one or more secondary systems is managing the load temporarily.

In certain instances, telemetry of each aircraft can be received through ATC primary radar (if available), ATC secondary radar (receiving aircraft ADSB transceiver), ATC ground radar, airport sensor systems such as Airport Surface Detection Equipment (ASDE), internet based data sources, or any combination thereof. One of ordinary skill in the art would appreciate that there are numerous methods and systems for receiving telemetry data, and all appropriate forms are contemplated for use with embodiments of the present invention.

FIG. 4B illustrates a block diagram of additional optional components of an example ground monitoring system 401, in accordance with examples of the present disclosure. In one example, ground monitoring system 401 optionally comprises ground interface module 407. Ground interface module 407 receives the monitoring results from ground monitoring module 405 and interfaces with ATC systems or controllers. In one example, ground interface module 407 interfaces with ATC monitors 422, by displaying warnings and highlighting the aircraft that deviated from their clearances, including but not limited to, deviations of heading, altitude, speed, taxi routes, or any combination thereof. In other examples, ground interface module 407 interfaces with dedicated monitors 424 that are portable or permanently mounted in air traffic control centers to provide graphical interfaces for the controllers. In other examples, ground interface module 407 interfaces with audio devices 426 that are portable or permanently mounted in air traffic control centers to provide aural information, guidance and warnings to the controllers. In other examples, ground interface module 407 interfaces with one or more personal electronic devices associated with one or more controllers 428 such as smart phones, tablets, devices used as electronic flight bags, peripherals thereof, or any combination thereof. Graphical interfaces provided by ground interface module 407 may comprise highlighting the transmitting aircraft, displaying the assigned trajectory of the transmitting aircraft, displaying the assigned altitude of the transmitting aircraft, highlighting the aircraft that deviated from their clearances or any combination thereof. In one example, ground interface module 407 overlays extra information onto the radar display of the air traffic controller.

Ground interface module 407 also receives user inputs through ATC monitors 422, dedicated monitors 424, audio devices 426, controllers' personal electronic devices 428, or any combination thereof. Said user inputs can be used to adjust settings of ground monitoring system 401, including but not limited to, boundaries of airspace under control, choice of aircraft to monitor, choice of aircraft telemetry to monitor, warning display style, audio levels, or any combination thereof.

The entire ground monitoring system 401 can operate on systems including but not limited to computers with displays, laptop computers, tablet computers, smart phones, cloud-based servers, or any combination thereof. In certain instances and embodiments, additional equipment that provides connections to air traffic control radios, ATC primary or secondary radar systems, ATC radar monitors for data exchanges may be utilized. In some examples, all components of the ground monitoring system 401 can operate on a single device located in the air traffic control center. In other examples, components of ground monitoring system 401 can be operated on multiple devices at different locations, connected through the hardwire data lines, wireless data transmission systems, connected by the internet, or any combination thereof.

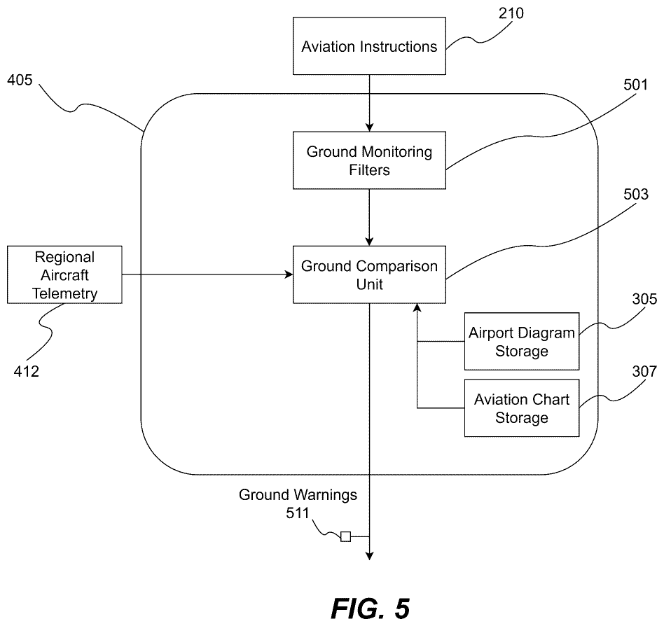

FIG. 5 illustrates a block diagram of one implementation of a ground monitoring module, in accordance with examples of the present disclosure. In a preferred embodiment, ground monitoring module 405 is configured to take aviation instructions 210 from transmission processing module 103. Aviation instructions 210 are then passed into ground monitoring filters 501. In one implementation, ground monitoring filter 501 disables the monitoring of certain parameters based on air traffic controller settings. Parameters that could be monitored and disabled include, but are not limited to aircraft heading, altitude, speed, geoposition or distance to other aircraft. In one example, airport ground controllers who do not actively control aircraft altitude can disable the monitoring of aircraft altitude. In other embodiments, ground monitor filter 501 could be configured to prioritize certain parameters based on air traffic controller settings, such as aircraft heading, altitude, speed, geoposition or distance to other aircraft. The output of ground monitoring filter 501 is passed into ground comparison unit 503, which also takes regional aircraft telemetry 412 as input. Ground comparison unit 503 compares the aircraft telemetry with the assigned values from the ATC transmission for each aircraft under the control of the air traffic controller or air traffic control center, and outputs ground warnings 511 when deviations are detected. Ground monitoring module 405 optionally comprises airport diagram storage 305 and aviation chart storage 307, to assist in the monitoring of compliance of taxi instructions or routes. In one implementation, airport diagram storage 305 and aviation chart storage 307 in the ground monitoring unit 405 are the same as those used in the airborne monitoring unit 105.

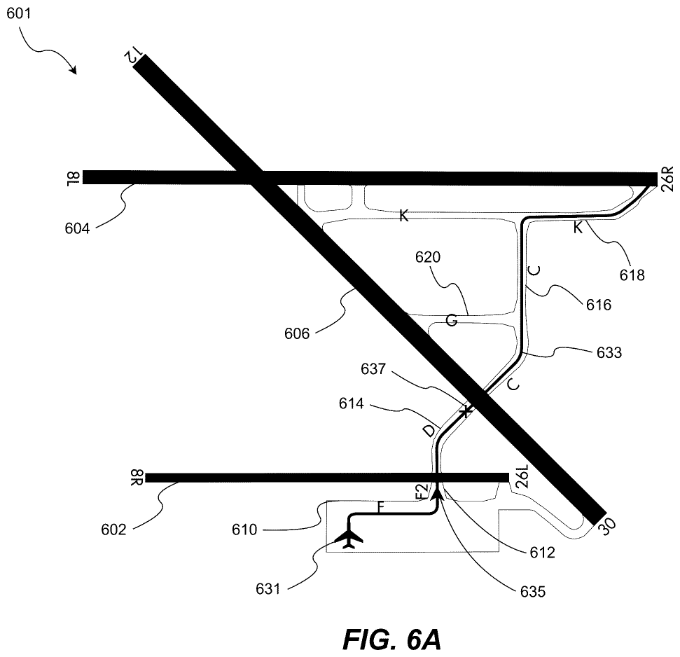

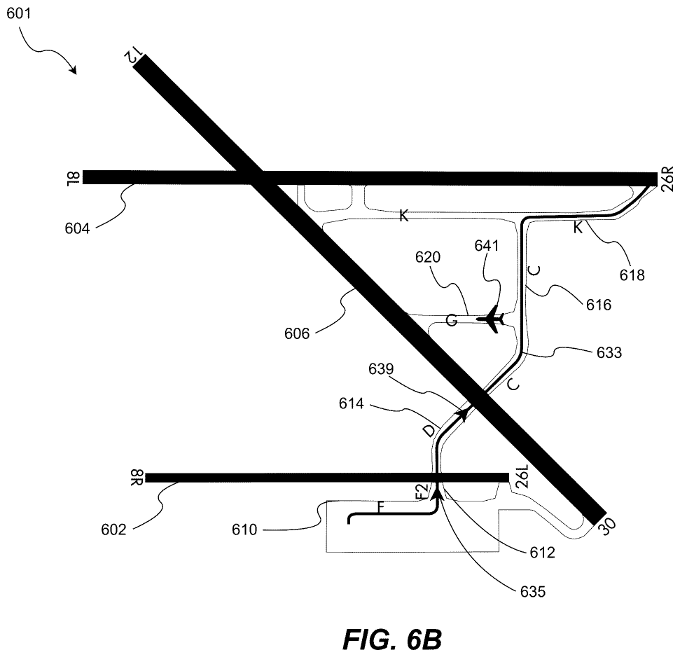

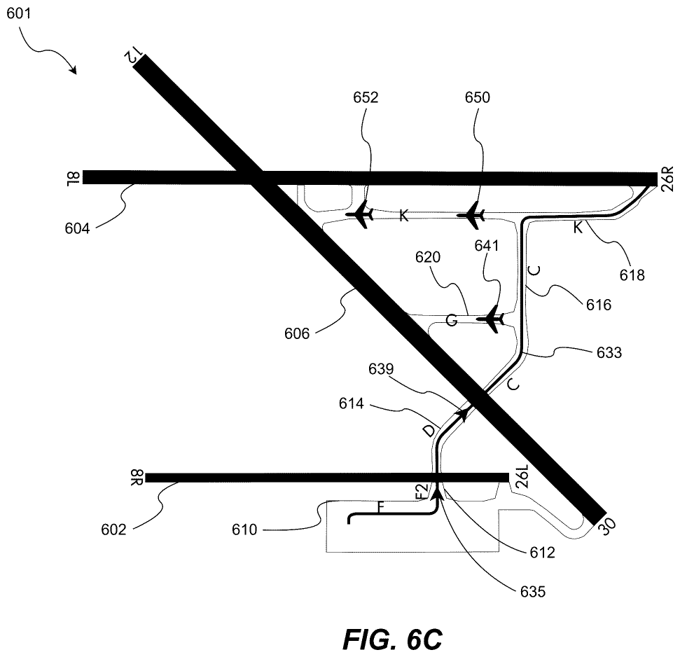

FIG. 6A illustrates a sample output of the airborne monitoring system 101 displaying an assigned taxi route with associated clearances, in accordance with examples of the present disclosure. Image 601 is a simplified airport diagram, comprising three runways, 602 is runway 8 right or runway 26 left (depending on the takeoff or landing direction, 604 is runway 8 left or 26 right, and 606 is runway 12 or 30. Airport diagram 601 further comprises a number of taxiways, taxiway F (read as “Foxtrot”) 610, taxiway F2 (read as “Foxtrot two”) 612, taxiway D (read as “Delta”) 614, taxiway C (read as “Charlie”) 616, taxiway K (read as “Kilo”) 618, taxiway G (read as “Golf”) 620.

In one example, 631 marks the current location of the aircraft with call sign “N123”. In this example, the aircraft receives a transmission 110 from the ATC in the form of audio transmission 202: “N123, LA ground, taxi runway 26 right via Foxtrot, Foxtrot two, cross runway 26 left, Delta, hold short of runway 30, Charlie, Kilo”.

In this example, on the aircraft side, this transmission 110 is processed by airborne monitoring system 101. The transmission 110 is first processed by transmission processing module 103 to obtain the aviation instructions 210, which is a data package identifying the source of transmission as LA ground, target of transmission as N123, and is a taxi route assignment with destination runaway 26 right and specific taxiways for the route. The aviation instructions 201 may also include a runway crossing clearance to cross runway 26 left but hold short (do not cross) runway 30. The airborne monitoring module 105 then uses the aviation instructions 210, the aircraft telemetry 112, and airport diagram from the airport diagram storage 305 to compute the assigned taxi route. In one example, the current aircraft telemetry 112 includes the current aircraft location obtained from a tablet used by the pilot as an electronic flight bag. Airborne interface module 107 then generates a graphic with the current aircraft location 631 and the computed taxi route 633 overlaid onto the airport diagram as shown in FIG. 6A. Additionally, in one example, the clearance to cross runway 26 left (602) is overlaid onto the airport diagram as an arrow 635, and the instruction to hold short of runway 30 (606) is overlaid onto the airport diagram as a cross 637. Additionally, colors and different graphical elements can be used for differentiating different clearances. In one example, runway crossing clearances can be displayed with green with runway hold short instructions shown in red. In another example, a portion of taxi route with clearance (from current aircraft location 631 until the hold short instruction of runway 30) can be displayed with solid line, while the remaining route that requires further clearance (clearance to cross runway 30) can be displayed with dashed line. The entire graphic is then displayed on pilot personal electronic device 128. In one example, 128 is the tablet used by the pilot as an electronic flight bag. This provides the pilot with a graphical guidance of the assigned taxi route that can be followed with less pilot workload.

FIG. 6B illustrates a sample output of the airborne monitoring system 101 when the aircraft deviated from the assigned taxi route, in accordance with examples of the present disclosure. In this example, the aircraft then received a second transmission 210 from ATC: “N123, LA ground, cleared to cross runway 30, continue taxi.” This transmission 210 is similarly processed by airborne monitoring system 101 and the obtained aviation instructions 210 is now a data package identifying the source of transmission as LA ground, target of transmission as N123, and is a clearance to cross runway 30. The airborne interface module 107 then updates the graphics displayed on pilot personal electronic device 128 with the clearance to cross runway 30 as shown by the arrow 639 in FIG. 6B.

In one example, the aircraft further taxied but made an incorrect left turn onto taxiway G as shown by the updated aircraft location 641 in FIG. 6B. The airborne comparison unit 303 then detects a deviation of aircraft location with the assigned taxi route, and airborne warnings 311 are generated. Airborne warnings 311 are processed by airborne interface module 107 to alert the pilot of deviations. In some examples, the warnings are displayed onto aircraft instruments 122, such as the primary flight display or multi-function displays in the cockpit. In other examples, the warning are audio warning sounds generated by audio devices 126 in the cockpit. In other examples, the warnings are displayed on pilot personal electronic device 128 such as a tablet used by the pilot as an electronic flight bag. In one example, the warning of deviation from the assigned taxi route is presented to the pilot graphically by changing the aircraft icon 641 to red, by flashing the aircraft icon 641, or encircling the aircraft icon 641 with a circle. In another example, the warning of deviation is presented to the pilot by flashing the screen a few times. In some examples, deviations of different severity are displayed differently. For example, high severity deviations such as runway incursion (entering a runway without authorization) or deviations that could result in imminent collisions can be highlighted with red, bigger icons or more rapid screen flashing, while low severity deviations can be highlighted with yellow, smaller icons or slower screen flashing. In some implementations, graphical warnings may be accompanied by audible warnings. In certain embodiments, the system may be configured to, in conjunction with an airborne warnings 311, or independent therefrom, automatically engage the aircraft to make a maneuver or alter telemetry upon receipt of a critical warning that may result in a catastrophic collision or other negative impact event. In these embodiments, temporary control over one or more aircraft may be processed by the system in order to avoid potential disaster.

FIG. 6C illustrates a sample output of the ground monitoring system 401 highlighting an aircraft that deviated from its assigned taxi route, in accordance with examples of the present disclosure. In one example, there are three aircrafts under the control of the airport ground controller. The controller assigned taxi routes to each of the three aircraft via audio transmissions 202. All audio transmissions are processed by transmission processing module 103 into aviation instructions 210 and passed into ground comparison unit 503. Ground comparison unit 503 additionally receives regional aircraft telemetry 412 that comprises the location of said three aircraft. Ground comparison unit 503 uses the airport diagrams stored in the airport diagram storage 305 and aviation instructions 210 to compute the assigned taxi route for each aircraft and automatically updates the routes based on additional transmissions 110. Ground comparison unit 503 continuously compares the current aircraft position with the computed taxi route and generates ground warnings 511 when deviations are detected. In this example, a graphic as illustrated by FIG. 6C is generated by ground interface module 407. 601 is the airport diagram comprising runways 602, 604, 606 and taxiways 610, 612, 614, 616, 618, 620. Current locations of the three aircraft under control are marked with aircraft icons 641, 640, 652. In this example, aircraft 641 made an incorrect turn onto taxiway G while aircraft 640 and aircraft 652 are taxiing correctly on their assigned routes. In this example, route 633, which is the assigned taxi route of the deviating aircraft 641 is also highlighted on the graphic. Highlighting both the current location of the deviation aircraft 641 and the assigned route 633 can bring immediate attention of air traffic controllers to the aircraft and make the deviation obvious. In this example, assigned taxi routes of complying aircraft 650 and 652 are not shown to avoid cluttering the display.

Additionally, colors and different graphical elements can be used for differentiating aircraft appropriately following assigned clearances from aircraft deviating from assigned clearances. In this example, the deviating aircraft 641 can be highlighted in red, highlighted with a larger aircraft icon, highlighted with a circle around the aircraft icon, or highlighted with a flashing icon. The assigned route of the deviating aircraft 633 can also be highlighted in red or highlighted by flashing. In other examples, the callsign of the deviating aircraft 641 can also be displayed next to the aircraft icon for easier identification of the deviating aircraft and allow the controller to make immediate calls to the deviating aircraft to stop the dangerous situation from developing. In some examples, deviations of different severity are displayed differently.

The entire graphic can be displayed onto ATC monitors 422 overlaying onto existing graphics, on dedicated monitors 424, or ATC personal electronic devices 428. In other examples, audio warnings such as: “N123 deviated from assigned taxi route” can be issued through audio devices 426 to alert the aircraft controllers of the deviation.

In other examples, the assigned taxi routes for certain aircraft (even if they are complying with their assigned route and not automatically displayed) can be displayed with certain user interactions such as modifying a display setting, hovering a mouse over the aircraft icon or touching the aircraft icon on a touch screen interface.

In another example, the aircraft is currently flying heading 290 degrees, and transmission 110, which is an audio transmission 202: “N123, LA approach, good morning, turn left heading 270 degrees” is received.

On the aircraft side, this transmission may be processed by airborne monitoring system 101. Transmission processing module 103 identifies the key elements in this transmission, including the callsign of the intended destination of the transmission “N123”, source of the transmission “LA approach”, and the ATC instruction “turn left heading 270 degrees”. Said elements are packaged into a data package aviation instructions 210 and sent to the airborne monitoring module 105. Airborne monitoring module 105 also receives aircraft telemetry 112 and identifies the current aircraft heading to be 290 degrees, identifies a need to change aircraft heading to comply with instructions, and sends the information to airborne interface module 107. In one implementation, airborne interface module 107 automatically sets the heading bug on aircraft instruments 122 to 270 degrees to alter the pilot of a need for heading change. In another implementation, airborne interface module 107 automatically or semi-automatically (await pilot approval) sets the heading setting in the aircraft autopilot 120 to initiate a heading change. In another implementation, airborne interface module 107 automatically updates the projected aircraft trajectory on pilot personal electronic device 128 such as a tablet used by the pilot as an electronic flight bag. Furthermore, if the aircraft did not initiate a heading change within a typical response time (adjustable through system settings), airborne monitoring module 105 issues an airborne warning 311. In another example, the aircraft incorrectly turned to the right, deviating from ATC instructions. Airborne monitoring module 105 detects the incorrect heading change and issues another airborne warning 311. In another example, the aircraft continued the turn pass 270 degrees and overshoots by a typical tolerance (adjustable through system settings). Airborne monitoring module 105 detects the heading mismatch and issues another airborne warning 311. Airborne warnings 311 are presented to the pilot in different formats, such as flashing screens on aircraft instruments 122, audial warnings issued through audial devices 126, aircraft trajectories highlighted in red on aircraft instruments 122, or aircraft trajectories highlighted in red on pilot personal electronic device 128. Additionally, in certain embodiments, when a heading change is not processed within a typical response time as noted above, the system may be configured to continually recalculate an updated corrective heading based on telemetry and elapsed time to response. In this manner, where an initial heading was given as 270 degrees, but pilot or the system took longer than expected to respond, an updated heading may be generated at, for example, 267, or 272, to correct for the delay in response. The system can generate the correction in real time or near real time in order to ensure an aircraft returns to the correct path.

On the ground side, this transmission is processed by ground monitoring system 401. Transmission processing module 103 similarly identifies the key elements in this transmission and sends aviation instructions 210 to the ground monitoring module 405. Ground monitoring module 405 receives regional aircraft telemetry 412 including the current heading of aircraft “N123”, identifies a need to change aircraft heading to comply with instructions, and sends the information to ground interface module 407. In one implementation, ground interface module 407 updates the projected aircraft trajectory using the new heading on ATC monitors 422, on dedicated monitors 424, or on ATC personal electronic devices 428. Furthermore, if the aircraft did not initiate a heading change within a typical response time (adjustable through system settings), ground monitoring module 405 issues a ground warning 511. In another example, the aircraft incorrectly turned to the right, deviating from ATC instructions. Ground monitoring module 405 detects the incorrect heading change and issues another ground warning 511. In another example, the aircraft continued the turn pass 270 degrees and overshots by a typical tolerance (adjustable through system settings). Ground monitoring module 405 detects the heading mismatch and issues another ground warning 511. Ground warnings 511 are presented to the ATC controller in different formats, such as flashing screens on ATC monitors 422, audial warnings issued through audial devices 126, aircraft trajectories highlighted in red on ATC monitors 422, or aircraft trajectories highlighted in red on ATC personal electronic devices 428. Similar as to disclosed above, in addition to, or in lieu of ground warnings 511, the system may be configured to automatically take temporary control of an aircraft, or otherwise generate updated telemetry/headings based on real time information, without the need to receive updated heading instructions from ATC instructions.

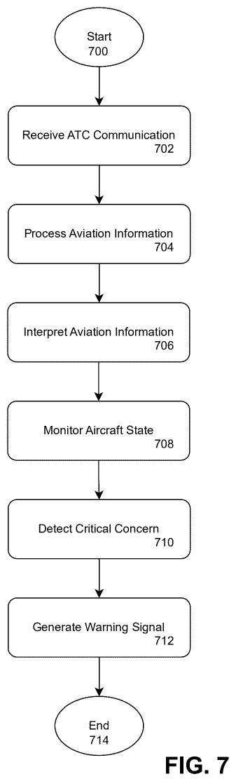

Turning now to FIG. 7, an exemplary method for providing in aircraft warnings is detailed, in accordance with an embodiment of the present invention. The process starts at step 700, with the system being engaged to process ATC communications for information related to flights in an area monitored by an ATC system. At step 702, the system, generally onboard an aircraft, receives an ATC communication. The ATC communications may be received in a manner detailed elsewhere herein, including, but not limited to, via an over-the-air (OTA) communication (e.g., radio communication), or a data communication received via electronics onboard the aircraft (e.g., via data signal from satellite or other OTA data communication).

At step 704, the system processes the ATC communication for information specifically about the aircraft. ATC communications may contain information about numerous aircraft in the monitored airspace, so the system particularly processes the information in the ATC communication to identify data specifically related to the aircraft the system is engaged to work in conjunction with. This is not solely information about the aircraft, but also involves interpreting information about other aircraft in the monitored airspace that may be of concern to the aircraft monitored by the system. For instance, interpreting information from the ATC communication may also involve interpreting and tracking information about other aircraft in the vicinity of the system monitored aircraft, to ensure updates related to other aircraft will not lead to a critical event with the system monitored aircraft.

At step 706, the system interprets the aviation information, which may include information about aircraft in the monitored airspace, including, but not limited to, trajectory information, taxi route, clearance command, grounding reference, flight route, hold short instruction, runway crossing instruction, runway assignment, and telemetry data of other aircraft. The system processes this information to ensure that changes will not lead to a critical event with the system monitored aircraft.

At step 708, the system continues to monitor updates related to the system monitored aircraft. By processing the data contained in the ATC communications, the system is providing a continuous mapping of aircraft and other concerns that may impact the system monitored aircraft.

At step 710, the system identifies a critical concern for the system monitored aircraft. A critical concern could be any data point that could create an issue for the system monitored aircraft, including, but not limited to, collision or proximity warnings, expected traffic concerns in the air or on the ground, weather related concerns, or any combination thereof. Upon identifying a critical concern, the system generates a warning signal at step 712. The warning signal could be any type of warning signal as detailed elsewhere herein, including, but not limited to, pilot perceptible warnings (audible warnings, visual warnings, haptic feedback), machine perceptible warnings (e.g., triggers in software), or any combination thereof. In addition, the system may utilize machine perceptible warnings to make modifications to flight systems of the system monitored aircraft, such as automatically updating settings on an autopilot system of the system monitored aircraft. At this point, the process terminates at step 714.

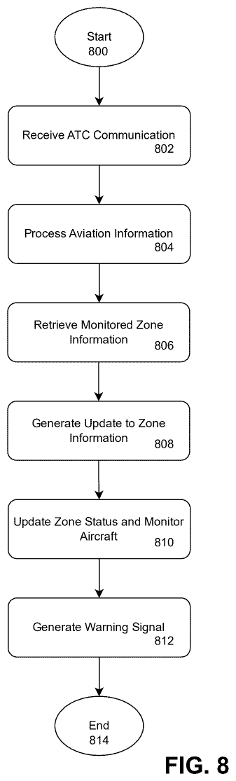

Turning now to FIG. 8, an exemplary method for generating warnings at an ATC system is detailed, in accordance with an embodiment of the present invention. The process starts at step 800, with the system being engaged to process ATC communications for information related to flights in an area monitored by an ATC system. At step 802, the system, generally in an ATC control center, receives or otherwise processes an ATC communication. The ATC communications may be received in a manner detailed elsewhere herein, including, but not limited to, via an over-the-air (OTA) communication (e.g., radio communication), or a data communication received via electronics at the ATC control center (e.g., via data signal from satellite or other OTA data communication, wired communications).

At step 804, the system processes the ATC communication for information specifically about aircraft in space monitored by the ATC center, which may include airspace, ground space, or any combination thereof. ATC communications may contain information about numerous aircraft in the monitored space. This is not solely information about aircraft in the monitored space, but also involves interpreting information about other data available to the ATC center related to the monitored space that may be of concern to the aircraft monitored by the system. For instance, interpreting information from the ATC communication may also involve interpreting and tracking information about other non-aircraft vehicles, personnel, obstructions or events (e.g., weather) in the vicinity of the system monitored aircraft, to ensure updates related to aircraft will not lead to a critical event with the aircraft monitored by the ATC control system.

At step 806, the system retrieves information related to the space monitored by the ATC control system. This may include, but is not limited to, information related to the airspace in the monitored zone, information related to the ground facilities (e.g., airport runways, control towers, gates, terminals) in the monitored zone, information related to events in the monitored zone (e.g., weather), or any combination thereof.

At step 808, the system generates an update to the zone information for the monitored zone based at least in part on the information processed from the ATC communication. Here, the ATC center is processing information on all data points available to it related to the monitored zone, including, but not limited to, aircraft, ground vehicles, personnel, runways, taxi paths, terminals, gates, or any combination thereof. Advantageously, the system actively monitors the entire zone for potential issues. In certain embodiments, the system can be configured to generate all these data points into a graphical display for provision on a graphical user interface usable by personnel monitoring the zone.

At step 810, the system identifies a critical concern for the system monitored zone. A critical concern could be any data point that could create an issue for the system monitored data points, including, but not limited to, collision or proximity warnings for aircraft, expected traffic concerns in the air or on the ground, weather related concerns, or any combination thereof. Upon identifying a critical concern, the system generates a warning signal at step 812. The warning signal could be any type of warning signal as detailed elsewhere herein, including, but not limited to, perceptible warnings (audible warnings, visual warnings, haptic feedback), machine perceptible warnings (e.g., triggers in software), or any combination thereof. In certain embodiments, the system may be configured to transmit additional warnings to monitored aircraft that would potentially be impacted by the critical concern. Advantageously, this dramatically reduces the reaction time for sending critical alerts to aircraft that could be impacted by the critical concern. In addition, certain embodiments of the system may utilize machine perceptible warnings transmitted to monitored aircraft to make modifications to flight systems of the system monitored aircraft, such as automatically updating settings on an autopilot system of the system monitored aircraft. At this point, the process terminates at step 814.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

1. A computerized system for autonomous air traffic monitoring comprising:
a processor and a non-transitory memory; the memory storing instructions which, when executed by the processor, cause the processor to:
receive, via a communications processing unit, an air traffic control (ATC) transmission relating to a first aircraft, wherein the ATC transmission is transmitted via a first data transmission type and comprises a one or more of, an audio transmission, a digital text transmission, one or more geospatial coordinates;
interpret, via the communications processing unit, aviation information contained in the ATC transmissions, wherein aviation information comprises one or more of trajectory information, taxi route, clearance command, ground reference, flight route, hold short instruction, runway crossing instruction, runway assignment, and telemetry data of other aircraft;
monitor, via the processor, a state of the first aircraft with respect to the interpreted transmission and prior transmissions; and.
generate a warning signal for the first aircraft, based at least in part on the aviation information and the state of the first aircraft, wherein the warning signal designates a delta between at least a portion of the aviation information and the state of the first aircraft.

2. The system of claim 1, wherein additional information associated with the first aircraft are sampled from one or more sensors selected from the group comprising an aircraft ADSB transceiver, an aircraft instrument, one or more GPS receivers, and an aircraft flight computer.

3. The system of claim 2, wherein processed ATC transmission data is regarded in comparison with the additional information sources.

4. The system of claim 1, wherein the warning signal comprises a signal perceptible to a pilot of the first aircraft.

5. The system of claim 1, wherein the warning signal comprises a signal perceptible to an electronic device of the first aircraft.

6. The system of claim 1, wherein the processor and the non-transitory memory further comprise instructions, when executed by the processor, cause the processor to:
adjust autopilot settings of the first aircraft, based at least in part on processed ATC transmission.

7. The system of claim 1, wherein the processor and the non-transitory memory further comprise instructions, when executed by the processor, cause the processor to:
adjust one or more instrument settings of the first aircraft, wherein the instrument settings are selected from the group comprising, heading bugs, altitude bugs, speed bugs, aircraft altimeter settings, radio frequency settings, and/or navigation equipment settings.

8. The system of claim 1, wherein the processor and the non-transitory memory further comprise instructions, when executed by the processor, cause the processor to:
overlay aircraft telemetry detected in the ATC transmission onto a graphical monitoring device of the first aircraft.

9. The system of claim 1, wherein the interpretation of the ATC transmission comprises altering from the first data transmission type to one or more secondary data types.

10. The system of claim 1, wherein the processor and the non-transitory memory further comprise instructions, when executed by the processor, cause the processor to:
output the aviation data to a model consumable by one or more electronic devices.

11. A computerized method for autonomous air traffic monitoring, the computerized method comprising the steps of:
receiving, via a communications processing unit, an air traffic control (ATC) transmission relating to a first aircraft, wherein the ATC transmission comprises one or more of, an audio transmission, a digital text transmission, one or more geospatial coordinates;
interpreting, via the communications processing unit, aviation information contained in the ATC transmission, wherein aviation information comprises one or more of trajectory information, taxi route, clearance command, grounding reference, flight route, hold short instruction, runway crossing instruction, runway assignment, and telemetry data of other aircraft;
monitoring, via a processor, a state of the first aircraft with respect to the interpreted transmission and prior transmissions; and.
generating a warning signal for the first aircraft, based at least in part on the aviation information and the state of the first aircraft, wherein the warning signal designates a delta between at least a portion of the aviation information and the state of the first aircraft.

12. The computerized method of claim 11, wherein additional information associated with the first aircraft are sampled from one or more sensors selected from the group comprising an aircraft ADSB transceiver, an aircraft instrument and an aircraft flight computer.

13. The computerized method of claim 11, wherein processed ATC transmission data is regarded in comparison with the additional information sources.

14. The computerized method of claim 11, wherein the warning signal comprises a signal perceptible to a pilot of the first aircraft.

15. The computerized method of claim 11, wherein the warning signal comprises a signal perceptible to an electronic device of the first aircraft.

16. The computerized method of claim 11, further comprising the step of adjusting autopilot settings of the first aircraft, based at least in part on processed ATC transmission.

17. The computerized method of claim 11, further comprising the step of adjusting one or more instrument settings of the first aircraft, wherein the instrument settings are selected from the group comprising, heading bugs, altitude bugs, speed bugs, aircraft altimeter settings, radio frequency settings, and/or navigation equipment settings.

18. The computerized method of claim 11, further comprising the step of overlaying aircraft telemetry detected in the ATC transmissions onto a graphical monitoring device of the first aircraft.

19. The computerized method of claim 11, wherein the interpretation of the ATC transmission comprises altering from the first data transmission type to one or more secondary data types.

20. The computerized method of claim 11, further comprising the step of outputting the aviation data to a model consumable by one or more electronic devices.

21. A system for aircraft state monitoring, comprising:
a processor and a non-transitory memory; the memory storing instructions which, when executed by the processor, cause the processor to:
receive an air traffic control (ATC) transmission;
interpret, via said processor, aviation information contained in said ATC transmission into an aircraft status change message, wherein the aircraft status change message relates to one or more aircraft in a zone monitored by the processor; and
generate a zone status related to the one or more aircraft in the zone monitored by the processor based at least in part on said aircraft status change message; and
monitor states of the one or more aircraft based at least in part on interpreted transmission and prior transmissions.

22. The system of claim 21, wherein the processor and the non-transitory memory further comprise instructions, when executed by the processor, cause the processor to:
generate a warning message for one or more of the one or more aircraft; and
transmit said warning message to the one or more aircraft of said one or more aircraft.

23. The system of claim 21, wherein the ATC transmission comprises a plurality of digital formats said plurality of digital formats selected from the group comprising audio, text, and geospatial coordinates.

24. The system of claim 21, wherein an origin of the ATC transmission is a ground-based controller.

25. The system of claim 21, wherein an origin of the ATC transmission is a first aircraft selected from the group of one or more aircraft.

26. The system of claim 21, wherein the ATC transmission comprises data selected from the group comprising taxi routes, clearance commands, grounding references, flight routes, hold short instructions, runway crossing instructions, runway assignments, and telemetry data.

27. The system of claim 21, wherein the processor and the non-transitory memory further comprise instructions, when executed by the processor, cause the processor to process additional information selected from the group comprising: primary radar, secondary radar, surface movement radar, ground-based ADSB receivers, satellite-based ADSB receivers, or aircraft ADSB transceivers.

28. The system of claim 27, the processor and the non-transitory memory further comprise instructions, when executed by the processor, cause the processor to: generate an updated zone status, based at least in part on said zone status and said additional information.

29. The system of claim 21, wherein the processor and the non-transitory memory further comprise instructions, when executed by the processor, cause the processor to display a graphical representation of said zone status on one or more displays selected from the group comprising ATC graphical displays, radar displays.

30. The system of claim 29, wherein the graphical representation is selected from the group comprising regional aircraft locations, indication of transmitting aircraft, assigned trajectory of regional aircraft, and indications of deviations from assigned trajectories.

31. The system of claim 21, wherein the processor and the non-transitory memory further comprise instructions, when executed by the processor, cause the processor to generate and transmit issuance of a warning message.

32. The system of claim 21, wherein the processor and the non-transitory memory further comprise instructions, when executed by the processor, cause the processor to generate a proposal of modified aircraft trajectories and clearances for ATC approval.
